(19) United States
(12) Patent Application Publication
(10) Pub. No.: US 2008/0091742 A1
(43) Pub. Date: Apr. 17, 2008

(54) SYSTEM AND METHOD FOR DETECTING AND UPDATING GEOGRAPHICAL INFORMATION DATASET VERSIONS

(76) Inventor: Elizabeth Marshall, Boise, ID (US)

Correspondence Address: BLACK LOWE & GRAHAM, PLLC, 701 FIFTH AVENUE, SUITE 4800, SEATTLE, WA, 98104, US

(21) Appl. No.: 11/872,640

(22) Filed: Oct. 15, 2007

Related U.S. Application Data
(60) Provisional application No. 60/829,456, filed on Oct. 13, 2006.

(51) Int. Cl. G06F 17/30

(52) U.S. Cl. 707/203; 707/E17.001

(57) ABSTRACT

Software-executed methods employed by computer-based systems deployed via intranets and the Internet are described. The software-executed methods include computer readable instructions to allow access and to identify at least one changing attribute, either spatially related or alphanumerically related, that exists between an originally created Geographical Information System dataset file and its replicated variation or child versions. The computer readable instructions also provide for the synchronizing and storing the child versions to the parent or original dataset file in the Geographical Information System and to an external business system.

### CROSS REFERENCE To RELATED APPLICATIONS

This application claims priority to and incorporates by reference in its entirety U.S. Provisional Patent Application No. 60/829,456 filed Oct. 13, 2006.

### FIELD OF THE INVENTION

This invention relates generally to datasets, particularly to managing datasets related to Geographic Information Systems (GIS) and non-geographic enterprise business systems.

### BACKGROUND OF THE INVENTION

Environmental Systems Research Institute (ESRI) of Redlands, Calif., and other organizations, provides enterprise GIS software programs for executing computer-based algorithms upon GIS datasets. These software programs analyze and report the association of attribute information with the spatial information of geographic datasets. The association of attribute information with spatial information includes algorithms relating to data modeling, topological modeling, network modeling, cartographic modeling, map overlay, automated cartography, geo-statistics, geo-coding, and reverse geo-coding.

Most non-geographic enterprise business systems do not support multiple concurrent versions of their datasets. That is, they only support short-duration dataset transactions with schema locking and the state of the database as a means to represent the most recently committed dataset transaction.

Non-versioned business systems provide sufficient solutions for most types of business processes, but they do not fit most typical enterprise GIS operational scenarios where new and regenerating GIS datasets require multiple GIS editing techniques and versions, and where the attributes modified during these GIS editing sessions need to be updated in a separate non-geographic enterprise business system. For example, several construction plans for a site can be developed simultaneously, each using their own version of the infrastructure GIS data. New and modified attribute changes from each of these editing sessions will be selected for actual construction and subsequently transacted back into the default geodatabase and the non-geographic enterprise business system(s) data store. Conflicting or inaccurate changes will typically be flagged for correction prior to committing to the enterprise systems.

ESRI's spatial database, the geodatabase, does support long-duration transactions through a mechanism known as “versioning”. Versions represent various alternative views of the same data. A common work flow for a GIS editor is to create a new version, make assigned geometric or attribute changes, reconcile the modifications with the parent version and then post the data back to the parent. This process can take anywhere from a few minutes to several weeks or months, and may exhibit conflicting or inaccurate edits to occur in the non-geographic enterprise business system with the possibility that data from one editor may be overwritten by another editor in the enterprise business system.

### SUMMARY OF THE PARTICULAR EMBODIMENTS

Systems and methods employing a computer executable synchronization algorithm configured for the detection, monitoring, editing, and synchronization of geometric and attribute differences existing between at least two versions of Geographic Information Systems datasets files storable in at least one database. The computer executable synchronization algorithm may evaluate and synchronize spatial and attribute datasets between an original or parent dataset file and subsequent variations, derivations, or child versions of the parent or original dataset file. Alternate embodiments of the computer executable synchronization algorithm may synchronize parent and child versions located on different databases between the Geographic Information system and a non-geographic enterprise business system.

### BRIEF DESCRIPTION OF THE DRAWINGS

Embodiments of the present invention are described in detail below with reference to the following drawings.

FIG. 1 depicts a Method and System Overview of the GeoResults Sync Algorithm;

FIG. 2 depicts a flowchart illustration of the GeoResults Sync algorithm;

FIG. 3A depicts an alternate flowchart illustration, representing geospatial feature edits using GeoResults Toolbox, of sub-algorithm 104A of FIG. 2;

FIG. 3B depicts an alternate flowchart illustration, representing geospatial feature edits using GeoResults Data Loader, of sub-algorithm 104B of FIG. 2;

FIG. 3C depicts an alternate flowchart illustration, representing geospatial feature edits using GeoResults Mobile GoCollect!, of sub-algorithm 104C of FIG. 2;

FIG. 3D depicts an alternate flowchart illustration, representing geospatial feature edits using GeoResults Mobile Compact, of sub-algorithm 104D of FIG. 2;

FIG. 4A depicts an alternate flowchart illustration, representing geospatial-related attribute edits using GeoResults Mobile GoWork!, of sub-algorithm 110A of FIG. 2;

FIG. 4B depicts an alternate flowchart illustration, representing geospatial-related attribute edits using GeoResults Mobile GoRespond!, of sub-algorithm 110B of FIG. 2;

FIG. 4C depicts an alternate flowchart illustration, representing geospatial-related attribute edits using GeoResults Mobile GoAssess!, of sub-algorithm 110C of FIG. 2;

FIG. 5 depicts a flowchart illustration of sub-algorithm 120 of FIG. 2;

FIG. 6 depicts a flowchart illustration of sub-algorithm 160 of FIG. 2;

FIG. 7 depicts a flow chart illustration of sub-algorithm 200 of FIG. 2;

FIG. 8 depicts a flow chart illustration of sub-algorithm 240 of FIG. 2; and

FIG. 9 depicts a flowchart illustration of an example embodiment of the use of the GeoResults Sync algorithm.

### DETAILED DESCRIPTION OF THE PARTICULAR EMBODIMENTS

In general, detailed descriptions below describe software-executed methods that may be employed by computer-based systems deployed via intranets and the Internet to ascertain differences and reconcile the differences between original and duplicate dataset versions contained within a datafile. The software-executed methods include computer readable instructions to allow access and to identify at least one changing attribute, either spatially related or alphanumerically related, that exists between an originally created or parent version of a Geographical Information System dataset file and its replicated variation or child versions. The computer readable instructions also provide for the synchronizing and storing the child versions to the parent or original dataset file in the Geographical Information System and to an external business system.

Other particular embodiments provide for systems and methods for integrating spatial information stored in an enterprise geodatabase with other, external business systems so that opportunities to evaluate conflicts or data quality in the versioned geodatabase is made possible prior to committing changes in the default geodatabase and the non-geographic enterprise business systems. The particular embodiments that allow the advance evaluation of data quality or conflicts prevents cost errors associated with data overwriting or data incongruities between geographic based and non-geographic based enterprise systems. Other particular embodiments provide for the management of multiple geodatabase versions in a manner that synchronizes geodatabase default versions and non-geographic enterprise business systems in a cost-efficient and accurate manner. The management of multiple geodatabase versions provide for the handling of multiple editing sessions, and corresponding child versions, in a main office, regional offices, or with mobile field devices.

Yet other particular embodiments include an optimal point in the process to synchronize at least two GIS datasets under conditions when the GIS edits in the child version have been completed and the data are ready to be posted to the parent production or original version of the geodatabase.

Other particular embodiments allow for evaluation and identification of different datasets from a geodatabase using a GeoResults Sync Algorithm that sorts or classifies modifications to datasets by one or more type of editing; feature addition, feature modification, feature deletion, and modification of external business system attributes relating to work orders, service request inspections, or assessments. After sorting, the algorithm applies configurable business rules and prepares corresponding transactions to be executed against the integrated business system. The algorithm also examines the differences to ensure that the modified features meet the data requirements of the integrated business system. A report is produced for any modifications that violate the integrated business system requirements that can be used to correct the problems in the GIS feature dataset.

Still other particular embodiments include systems and methods for monitoring a changing GIS dataset version. The monitoring includes creating a database of historical or parent GIS datasets and modifying at least one GIS dataset derived from the database to form a new or child GIS dataset version. Attribute changes between the parent and child GIS dataset versions are compared, visualized, and synchronized in real time to the external enterprise business system's database. Thereafter the child GIS dataset version is posted to the parent dataset, and the child dataset version is typically deleted.

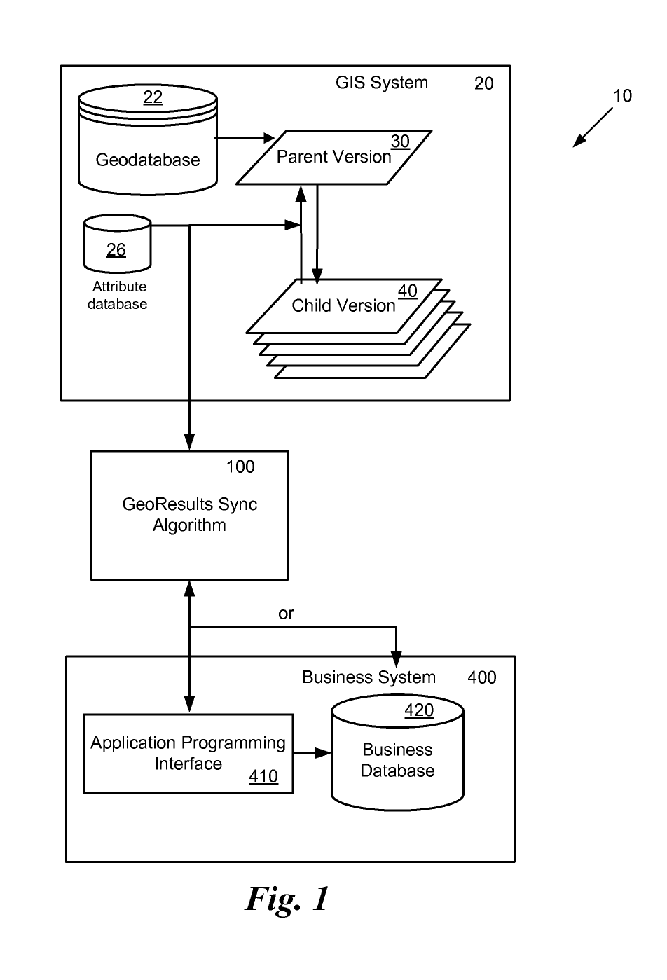

FIG. 1 depicts a Method and System utilizing the GeoResults Sync Algorithm. The system 10 includes a Geographic Information System (GIS) 20 in signal communication with a Business System 400. In general terms, FIG. 1 illustrates how the computer executable algorithm operates on, and synchronizes changes for, both GIS 20 and business systems 400. The GIS includes a Geodatabase 22 and may include an associated Attribute Database 26. The Business System 400 includes an application programming interface (API) 410 and a Business Database 420. Both the GIS 20 and the Business System 400 utilize computer based systems, displays, and server systems compatible with intranets and the Internet and that may employ wired, wireless, and combination of wired and wireless communications.

The method employs a computer executable synchronization algorithm the system 10 utilizes with the GIS 20 and Business System 400. The computer executable synchronization algorithm is referred to as the GeoResults Sync Algorithm (GSA) 100 that allows editing and workflow managing of GIS datasets or dataset versions occurring between a parent version 30 stored on the Geodatabase 22 and at least one child version 40 obtained from the Business System 400 or from the Geographic Information System's 20 Attribute Database 26. The child dataset versions 40 that the GSA 100 resolves editing may be obtained from either the Business System's 400 database API 410 and/or the Business Database 420.

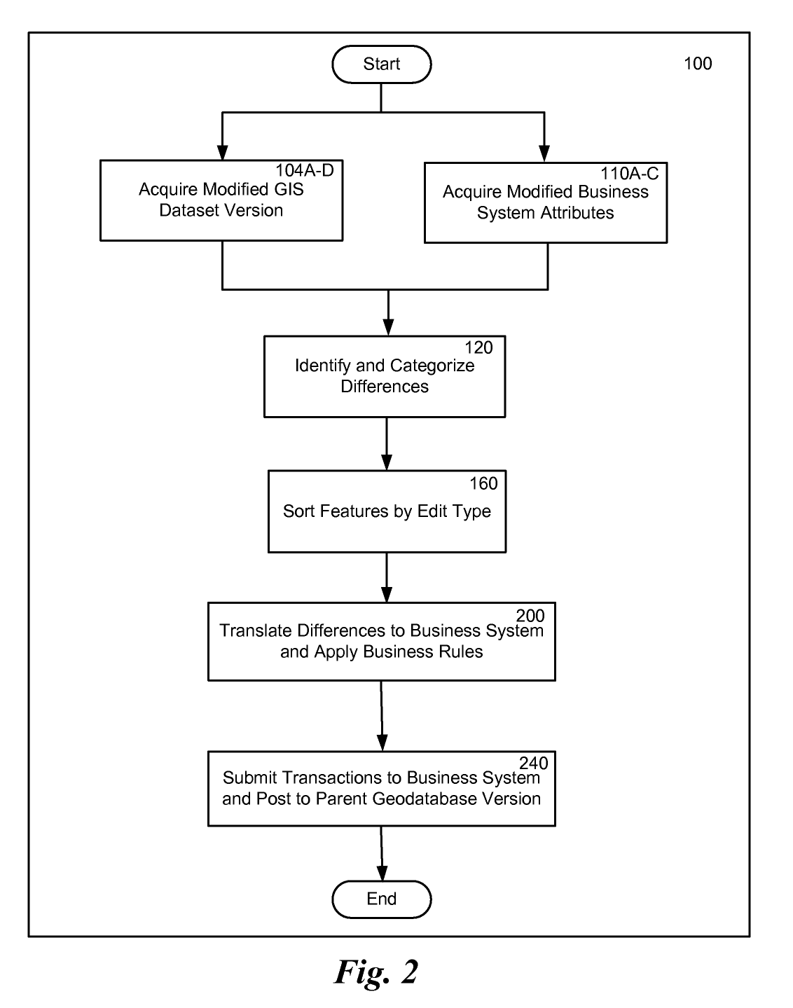

The GSA 100 is initiated at the point in a versioned editing workflow where the GSA's 100 editing functionality is readied to begin edits to the versioned geodatabase and business system attributes. Once the editor has completed the spatial and/or tabular edits then it is submitted back to the enterprise geodatabase 22 and Business System 400. The GSA 100 utilizes several software executable tools or modules described in FIGS. 2-8 below. These software tools provide data acquisition, processing, and analysis to resolve version differences between parent dataset version 30 and child data set versions 40. The software tools include a GeoResults Mobile GoMap! module, a GeoResults Mobile GoCollect! module, a GeoResults Mobile GoWork! module, a GeoResults Mobile GoRespond! module, a GeoResults Mobile GoAssess! module, a GeoResults Mobile Compact, a GeoResults Data Loader, and a GeoResults Toolbox. The GSA 100 also utilizes established ESRI tools or a customized tool insertable into the GeoResults Sync Algorithm 100.

In a particular embodiment, the user can execute the ESRI tool to reconcile edits made in the child version with the current parent or historical version. The reconcile tool identifies any changes made by the editor, and compares those changes to the parent version selected by the editor. It also identifies conflicts between the changes the editor has made and the parent. If any conflicts are detected using this tool, these must be resolved prior to committing the attribute data to the parent geodatabase 22 or the business system 400. Thereafter, results from the GeoResults Sync Algorithm 100, that do not conflict and meet the business rules, are routed to a business system database, or through its application-programming interface 410 for storage.

In another particular embodiment, the GeoResults Sync Algorithm 100 runs within the application process of, and as an extension to, ESRI's ArcMap product. The code references the ArcObjects library, and relies on that technology to gain access to the spatial features and difference cursors provided natively by ArcSDE. ArcObjects is a component object module (COM) compliant library of objects that provide mapping and analysis functionality through exposed interfaces. Accessing these interfaces allows an application to manipulate the spatial features stored in the GIS 20, utilizing ESRI's standard business logic.

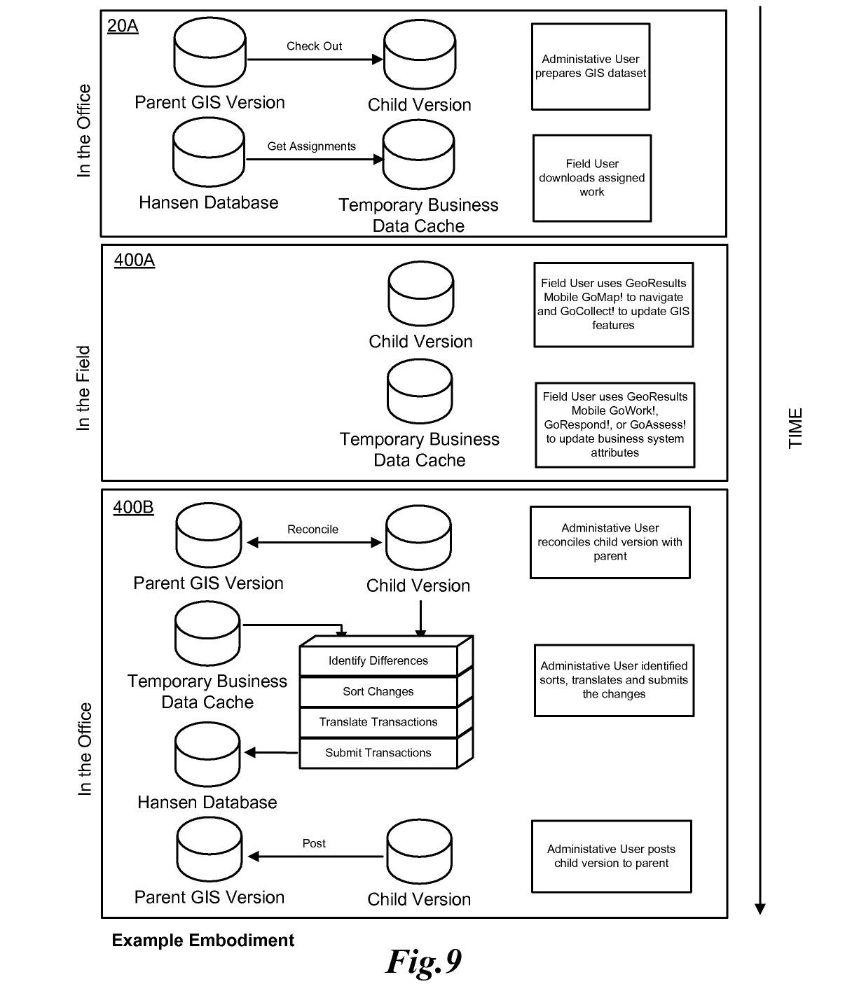

The algorithm utilizes the API 410 should the Business System 400 utilize it, to ensure that any changes made to the Business System's 400 data are compliant with the Business System's 400 vendor's data integrity rules. In addition, the GeoResults Sync Algorithm 100 uses the API 410 to determine data requirements of the Business System's 400 vendor and to evaluate modified GIS 20 features to ensure that they meet these requirements. For example, a typical GIS 20 editing operation could result in new physical features being created in the inventory. For each new feature, one or several corresponding actions could be triggered in the associated business system. An interface, such as CreateNewAsset in a Hansen database described in FIG. 9 below, serves to encapsulate and abstract the business logic of the target system.

ArcObjects exposes an interface that provides access to a version difference cursor based on the internal ArcSDE delta tables. This cursor enumerates the differences between the child and parent versions of the data. The GeoResults Sync algorithm 100 traverses this cursor to determine the changes that have been made since the child version was created. Each change listed in the cursor is reported to be of one of the following types:
1. A feature was inserted in the child version 40.
2. A feature has been deleted in the child version and not changed in the parent version 30.
3. A feature has been updated in the child version 40 and not changed in the parent version 30.
4. A feature has been updated in both parent and child versions 30 and 40.
5. A feature has been updated in the child version 40 but deleted in the parent version 30. A feature has been deleted in the child version 40 but updated in the parent version 30.
6. Taking the class of edit into consideration, as well as the associated feature's geometry and attribute values, the algorithm groups the edits into categories described more fully in FIGS. 2-8 below. Sub-algorithms described therein refer to editing users and administrative users. Editing users primarily make spatial changes to parent versions 30 to make or create at least one or many series of child dataset versions 40. The administrative user generally reviews and approves what the editing user submits. The editing user is active in the data acquisition step, the administrative user is the user that operates the id, sort, translate and submit routines. Administrative users may also create copies of the dataset parent versions 30 and distribute them the parent version 30 copies to editing users who subsequently make spatial changes to the administratively created copies to produce spatially edited child versions 40. The administratively created and distributed copies of the parent versions 30 may be distributed to more than one editing user, so that the copies of the parent versions 30 is disconnected in the sense that not all editing users see companion editing users copies of parent versions 30.

FIG. 2 depicts a flowchart illustration of the GeoResults Sync Algorithm 100. GSA 100 begins with two parallel processing blocks 104A-D, in which modified GIS dataset versions are acquired, and 110A-C, in which modified Business System 400 attributes are acquired. Acquired dataset versions and attributes thus acquired are evaluated in processing block 120 to examine, identify, and categorize dataset differences. Thereafter, at processing block 160, the feature differences are sorted by edit types, then, at processing block 200, the differences are translated to the Business System 400 and receive application of business rules. The GeoResults Sync Algorithm then is completed by executing processing block 240, in which transactions of child versions 40 are submitted to the Business System 400 and posted with the parent version 30 in the enterprise geodatabase 22 of GIS 20.

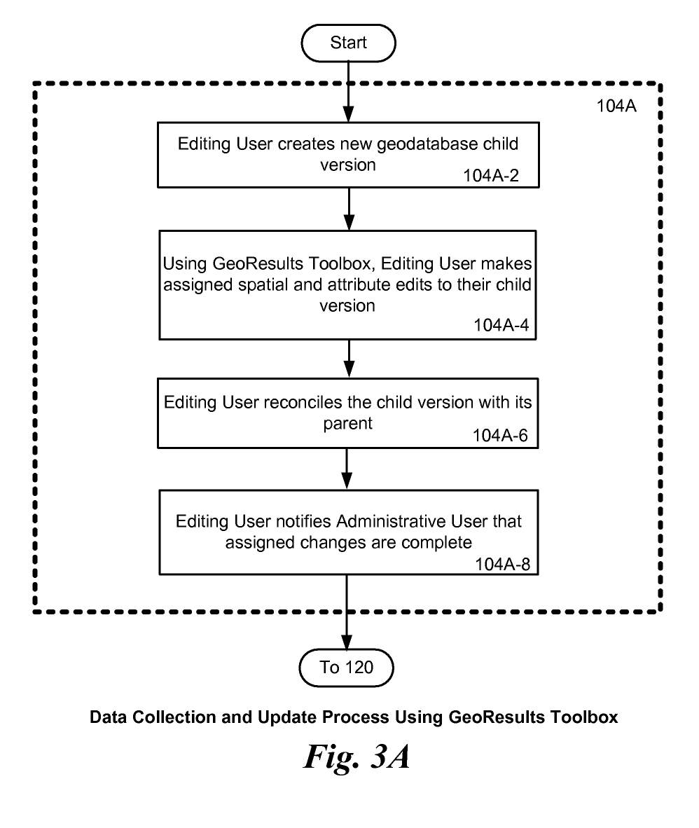

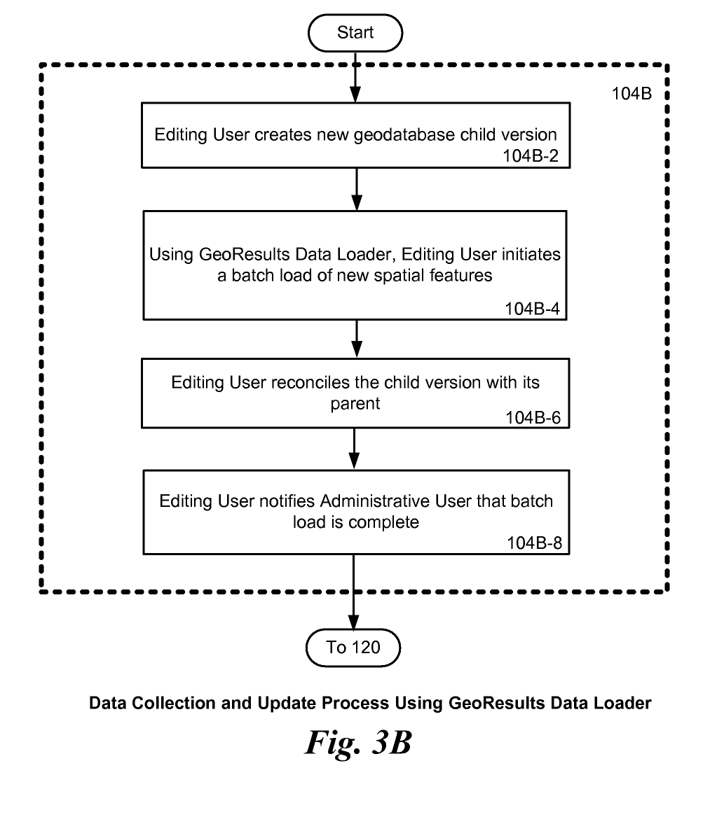

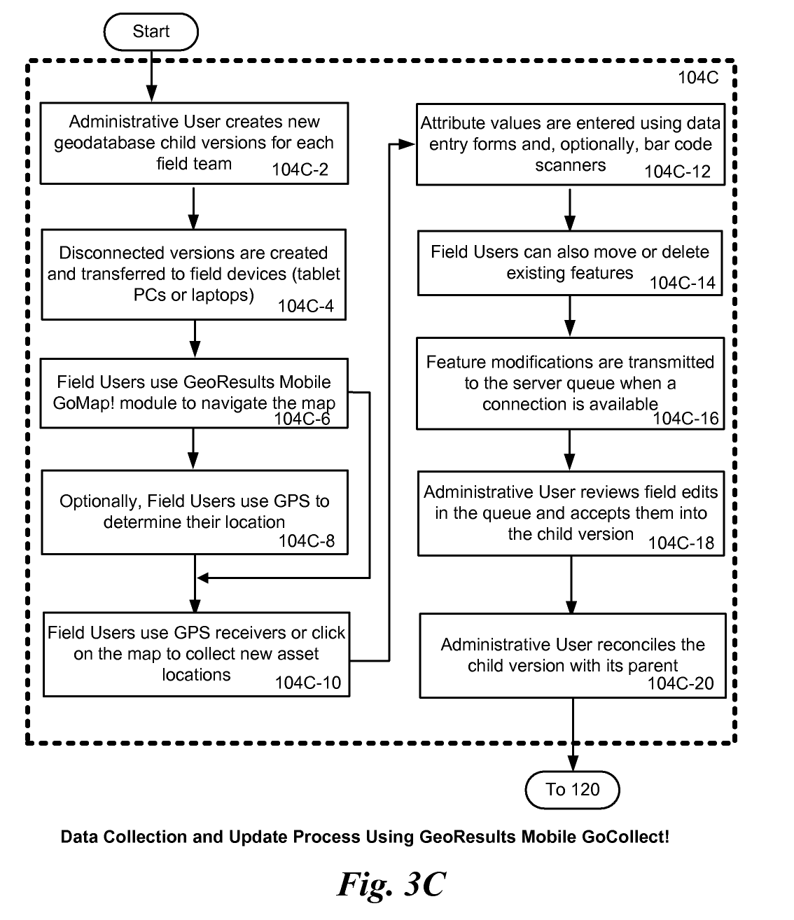

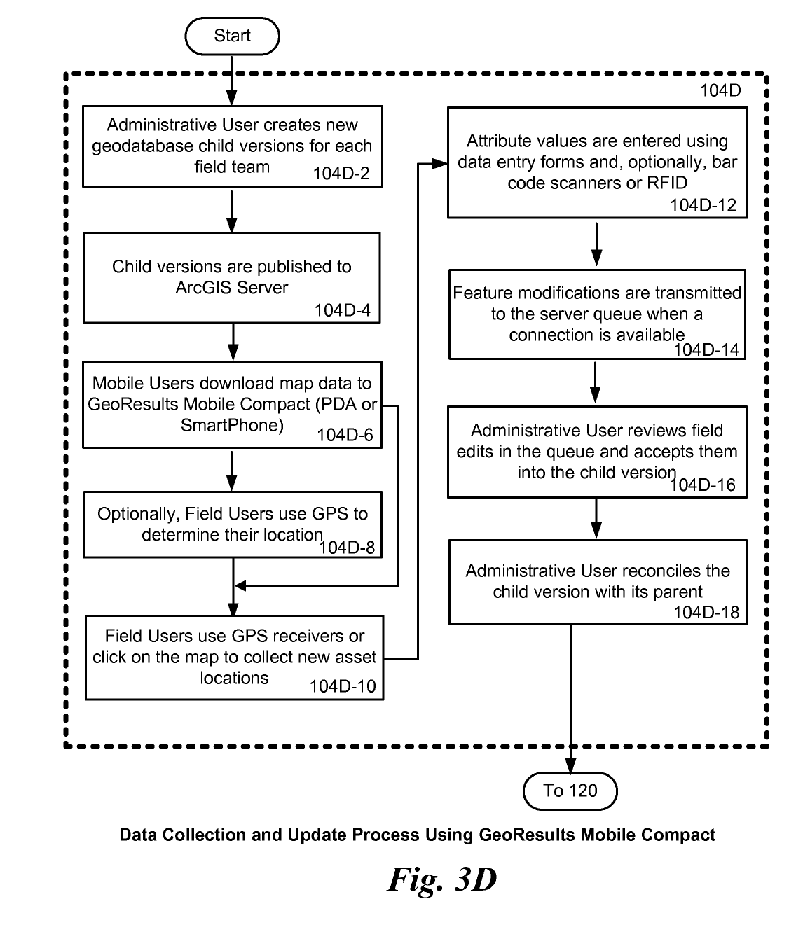

FIG. 3A depicts an alternate flowchart illustration, representing geospatial feature edits using GeoResults Toolbox, of sub-algorithm 104A of FIG. 2. Sub-algorithm 104A begins with processing block 104A-2 in which a new geodatabase child version 40 is created by an editing user. At processing block 104A-4, the new geodatabase child version 40 is edited in which assigned spatial and attribute edits are made by the editing user employing the GeoResults Toolbox. Thereafter, at processing block 104A-6, the child version 40 is reconciled with the parent version 30 by the editing user. Sub-algorithm 104A is then completed by processing block 104A-8 in which the editing user notifies the administrative user that the assigned changes are complete. Sub-algorithm 104A then proceeds to sub-algorithm 120.

FIG. 3B depicts an alternate flowchart illustration, representing geospatial feature edits using GeoResults Data Loader, of sub-algorithm 104B of FIG. 2. Sub-algorithm 104B begins with processing block 104B-2 in which a new geodatabase child version 40 is created by an editing user. At processing block 104B-4, the new geodatabase child version 40 is edited by the editing user who initiates a batch load of new spatial features employing the GeoResults Data Loader. Thereafter, at processing block 104B-6, the child version 40 is reconciled with the parent version 30 by the editing user. Sub-algorithm 104B is then completed by processing block 104B-8 in which the editing user notifies the administrative user that the assigned changes are complete. Sub-algorithm 104B then proceeds to sub-algorithm 120.

FIG. 3C depicts an alternate flowchart illustration, representing geospatial feature edits using GeoResults Mobile GoCollect!, of sub-algorithm 104C of FIG. 2. Sub-algorithm 104C begins with processing block 104C-2 in which a new geodatabase child version 40 is created by an administrative user for each field team of editing users equipped with field devices, for example tablet personal computers, laptops, or personal data assistants (PDAs). At processing block 104C-4, copies or disconnected or independent versions of the parent version 30 in the form of new geodatabase child version 40 is distributed for editing by the editing users in which either assigned spatial and/or attribute or other alphanumerical edits are made by the editing user employing the GeoResults Mobile GoCollect!. Thereafter, at processing block 104C-6, ¹. field users may interact with the digital map by clicking on the map to collect new asset locations. Alternatively, the field users may acquire global positioning system (GPS) coordinates to determine asset locations at processing block 104C-8, then proceed to block 104C-10 to the GPS receivers to retrieve coordinate values. Thereafter, at process block 104C-12, field users enter attribute values using data entry forms or optionally enter data via bar code scanners or radio frequency identification tags (RFID). Proceeding to block 104C-14, the field users may also move or delete existing features. Thereafter, at block 104C-16, feature modifications are transmitted to the server queue once a connection becomes available. At process block 104C-18, the administrative user reviews field edits in the queue and accepts or approves them into the child version 40. Thereafter, at process block 104C-20, the administrative user reconciles the child version 40 with the parent version 30. Data collection and update processing using GeoResults Mobile GoCollect! is accomplished and completed under sub-algorithm 104C and proceeds to sub-algorithm 120.

FIG. 3D depicts an alternate flowchart illustration, representing geospatial feature edits using GeoResults Mobile Compact described in sub-algorithm 104D of FIG. 2. Sub-algorithm 104D begins with processing block 104D-2 in which a new geodatabase child version 40 is created by an administrative user for each field team of editing users equipped with field devices, for example tablet personal computers, laptops, or personal data assistants (PDAs). At processing block 104D-4, copies are published to the ArcGIS server. Thereafter, at processing block 104D-6, mobile users download map data to GeoResults Mobile Compact via PDAs, Smartphones, or other mobile computer devices capable of wireless communication. Thereafter, at processing block 104D-10, field users may interact with the digital map by clicking on the map to collect new asset locations. Alternatively, the field users may acquire GPS coordinates to determine asset locations at processing block 104D-8, then proceed to block 104D-10 to the GPS receivers to retrieve coordinate values. Thereafter, at process block 104D-12, field users enter attribute values using data entry forms or optionally enter data via bar code scanners or RFID. Proceeding to block 104D-14, the field users may modify features and transmit and any modified features to the server queue once a connection becomes available. At process block 104D-16, the administrative user reviews field edits in the queue and accepts or approves them into the child version 40. Thereafter, at process block 104D-18, the administrative user reconciles the child version 40 with the parent version 30. Data collection and update processing using GeoResults Mobile Compact is accomplished and completed under sub-algorithm 104D and proceeds to sub-algorithm 120.

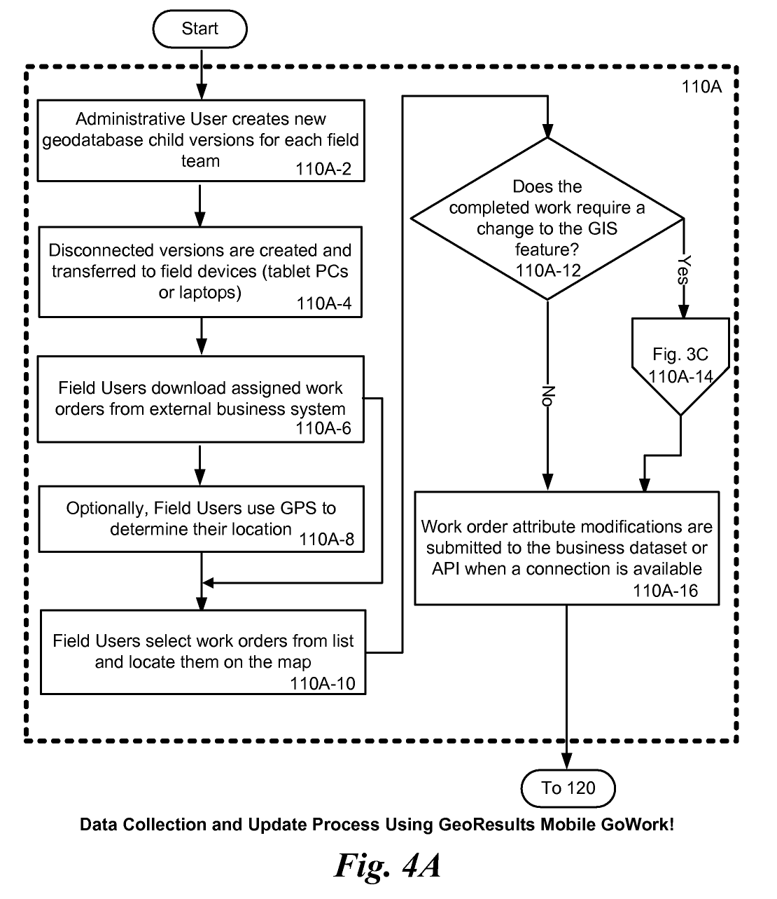

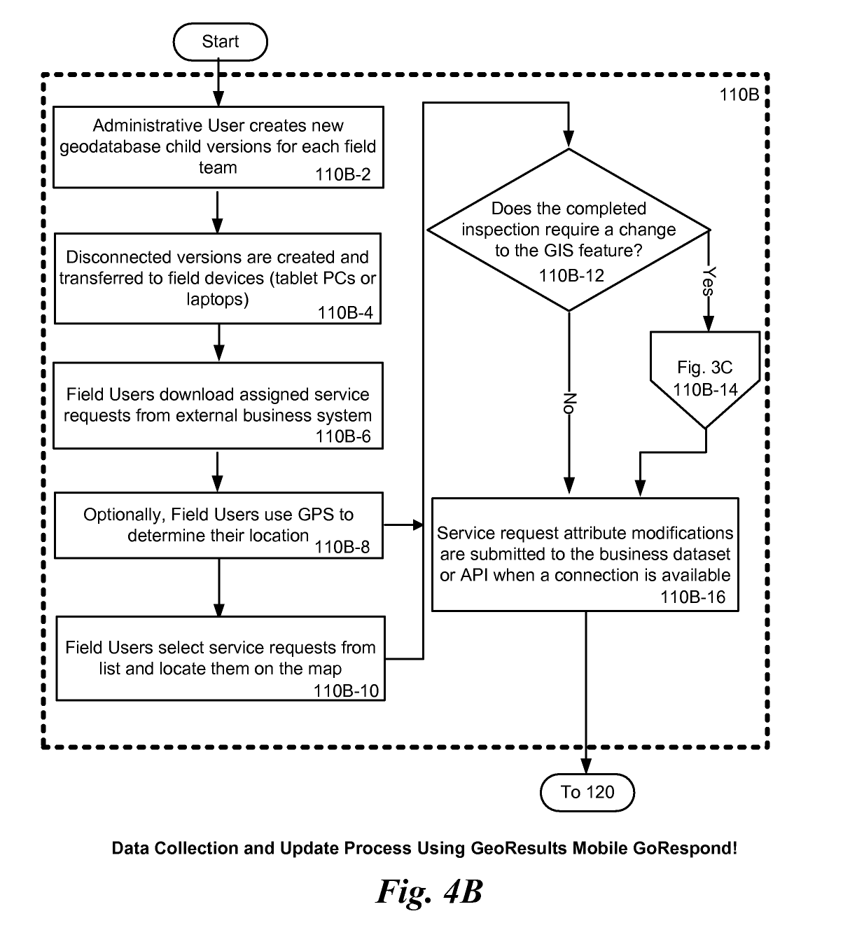

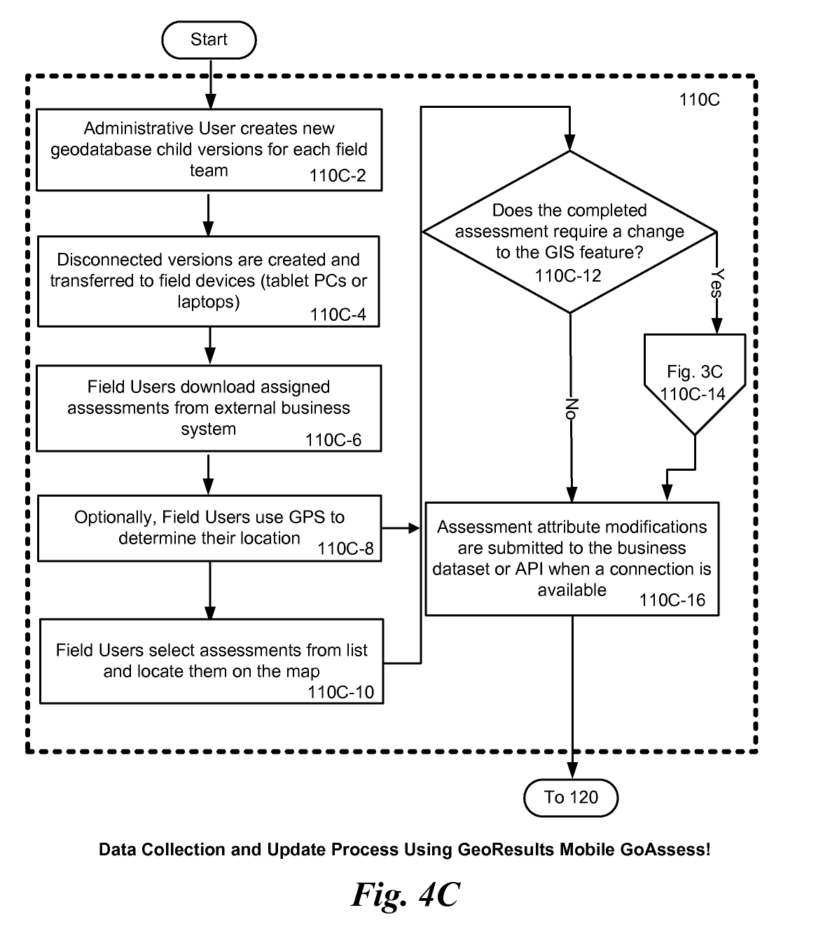

FIG. 4A depicts an alternate flowchart illustration, representing geospatial-related attribute edits using GeoResults Mobile GoWork!, of sub-algorithm 110A of FIG. 2. Sub-algorithm 110A begins with processing block 110A-2 in which a new geodatabase child version 40 is created by the administrative user for each field team of editing users equipped with field devices, for example tablet personal computers, laptops, or personal data assistants (PDAs). At processing block 110A-4, copies or disconnected or independent versions of the parent version 30 in the form of new geodatabase child version 40 is distributed for editing by the editing users in which either assigned spatial and/or attribute or other alphanumerical edits are made by the editing user employing the GeoResults Mobile GoWork! Thereafter, at processing block 110A-6, field users download assigned work orders from the external Business System 400 to via PDAs, Smartphones, or other mobile computer devices capable of wireless communication. Thereafter, at processing block 110A-10, field users may interact with the digital map by clicking on the map to collect new asset locations. Alternatively, the field users may acquire GPS coordinates to determine asset locations at processing block 110A-8, then proceed to block 110A-10 to the GPS receivers to retrieve coordinate values. Thereafter, at decision diamond 110A-12, field users are queried “Does the completed work require a change to the GIS feature”? If affirmative to the query, then sub-algorithm 110A returns to processing block 104C-14 and completes the remaining process blocks of FIG. 3C. Thereafter, at process block 110A-16, the work orders receive attribute modifications and are submitted as modified datasets to the Business System's 400 API 410 and/or database 420 once connection becomes available. If negative to the query of decision diamond 110A-12, direct procession to the afore described block 110A-16 occurs and data collection and update processing using GeoResults Mobile GoWork! is accomplished and completed under sub-algorithm 110A and proceeds to sub-algorithm 120.

FIG. 4B depicts an alternate flowchart illustration, representing geospatial-related attribute edits using GeoResults Mobile GoRespond!, of sub-algorithm 110B of FIG. 2. Sub-algorithm 110B begins with processing block 110B-2 in which a new geodatabase child version 40 is created by the administrative user for each field team of editing users equipped with field devices, for example tablet personal computers, laptops, or personal data assistants (PDAs). At processing block 110B-4, copies or disconnected or independent versions of the parent version 30 in the form of new geodatabase child version 40 is distributed for editing by the editing users in which either assigned spatial and/or attribute or other alphanumerical edits are made by the editing user employing the GeoResults Mobile GoRespond! Thereafter, at processing block 110B-6, field users download assigned work orders from the external Business System 400 to via PDAs, Smartphones, or other mobile computer devices capable of wireless communication. Thereafter, at processing block 110B-10, field users may interact with the digital map by clicking on the map to collect new asset locations. Alternatively, the field users may acquire GPS coordinates to determine asset locations at processing block 110B-8, then proceed to block 110B-10 to the GPS receivers to retrieve coordinate values. Thereafter, at decision diamond 110B-12, field users are queried “Does the completed inspection require a change to the GIS feature”? If affirmative to the query, then sub-algorithm 110B returns to processing block 104C-14 and completes the remaining process blocks of FIG. 3C. Thereafter, at process block 110B-16, the work orders receive attribute modifications and are submitted as modified datasets to the Business System's 400 API 410 and/or database 420 once connection becomes available. If negative to the query of decision diamond 110B-12, direct procession to the afore described block 110B-16 occurs and data collection and update processing using GeoResults Mobile GoRespond! is accomplished and completed under sub-algorithm 110B and proceeds to sub-algorithm 120.

FIG. 4C depicts an alternate flowchart illustration, representing geospatial-related attribute edits using GeoResults Mobile GoAssess!, of sub-algorithm 110C of FIG. 2. Sub-algorithm 110C begins with processing block 110C-2 in which a new geodatabase child version 40 is created by the administrative user for each field team of editing users equipped with field devices, for example tablet personal computers, laptops, or personal data assistants (PDAs). At processing block 110C-4, copies or disconnected or independent versions of the parent version 30 in the form of new geodatabase child version 40 is distributed for editing by the editing users in which either assigned spatial and/or attribute or other alphanumerical edits are made by the editing user employing the GeoResults Mobile GoAssess! Thereafter, at processing block 110C-6, field users download assigned work orders from the external Business System 400 to via PDAs, Smartphones, or other mobile computer devices capable of wireless communication. Thereafter, at processing block 110C-10, field users may interact with the digital map by clicking on the map to collect new asset locations. Alternatively, the field users may acquire GPS coordinates to determine asset locations at processing block 110C-8, then proceed to block 110C-10 to the GPS receivers to retrieve coordinate values. Thereafter, at decision diamond 110C-12, field users are queried “Does the completed assessment require a change to the GIS feature”? If affirmative to the query, then sub-algorithm 110C returns to processing block 104C-14 and completes the remaining process blocks of FIG. 3C. Thereafter, at process block 110C-16, the work orders receive attribute modifications and are submitted as modified datasets to the Business System's 400 API 410 and/or database 420 once connection becomes available. If negative to the query of decision diamond 110C-12, direct procession to the afore described block 110C-16 occurs and data collection and update processing using GeoResults Mobile GoAssess! is accomplished and completed under sub-algorithm 110C and proceeds to sub-algorithm 120.

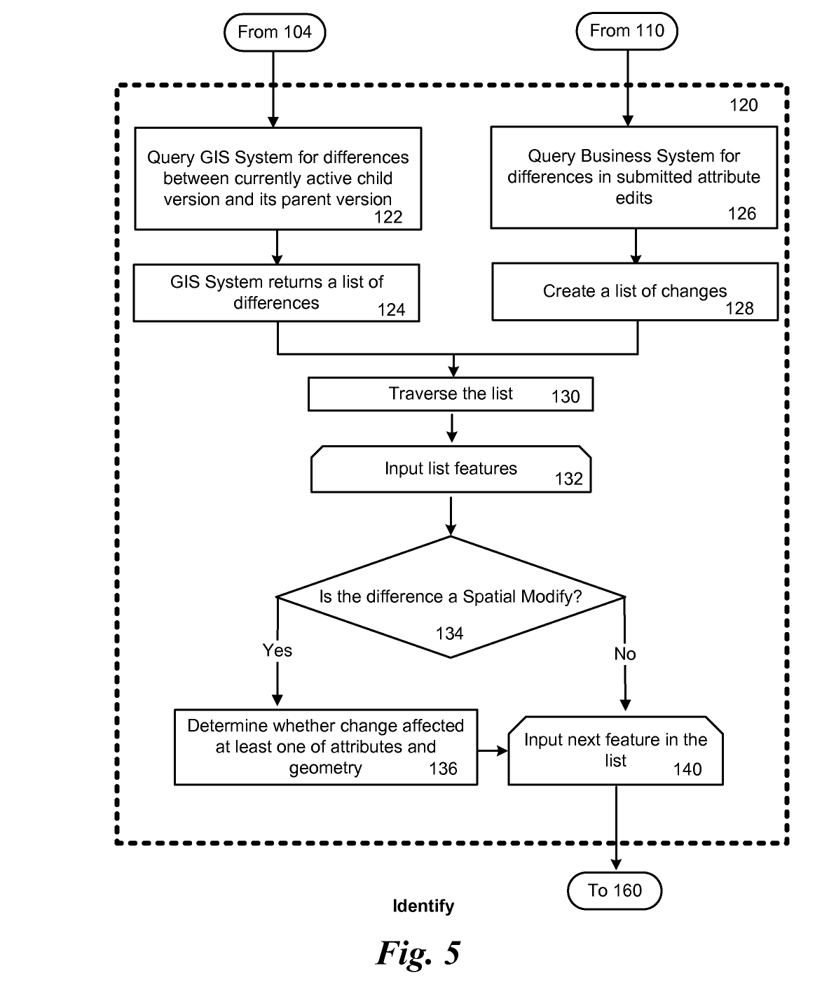

FIG. 5 depicts a flowchart illustration of sub-algorithm 120 of FIG. 2. In general terms, FIG. 5 describes a method of how to identify version differences. The features are identified by querying either the GIS system 20 and/or the Business System 400, identifying differences from results obtained from the queries, categorizing if the results are spatial or attribute related, and ascertaining whether the differences are definable as a spatial modification.

More particularly sub-algorithm 120 follows sub-algorithms 104 and 110 and begins with parallel process blocks 122 and 126. From sub-algorithm 104, at process block 122, the GIS 20 is queried for differences between a currently active child version 40 and its parent version 30. Thereafter, the GIS 20 returns a list of differences at process block 124. From sub-algorithm 110, at process block 126, the Business System 400 is queried for differences in submitted attribute edits of the child version 40 and its parent version 30. Thereafter, the Business system 400 creates a list of attribute changes and returns the list of attribute changes at process block 128. Following process blocks 124 and 128, at process block 130, the GIS 20 supplied list difference and the Business System supplied attribute change list are traversed for features. Thereafter, the features are inputted at process block 132, followed by a query “Is the difference a Spatial Modify” at decision diamond 134. If negative, then a next feature in the list is inputted at process block 140 and sub-algorithm 120 is completed at exits to sub-algorithm 160. If affirmative, then at process block 136 a determination is made whether the change affected at least one of attributes and geometry. Thereafter, then a next feature in the list is inputted at process block 140 and sub-algorithm 120 is completed at exits to sub-algorithm 160.

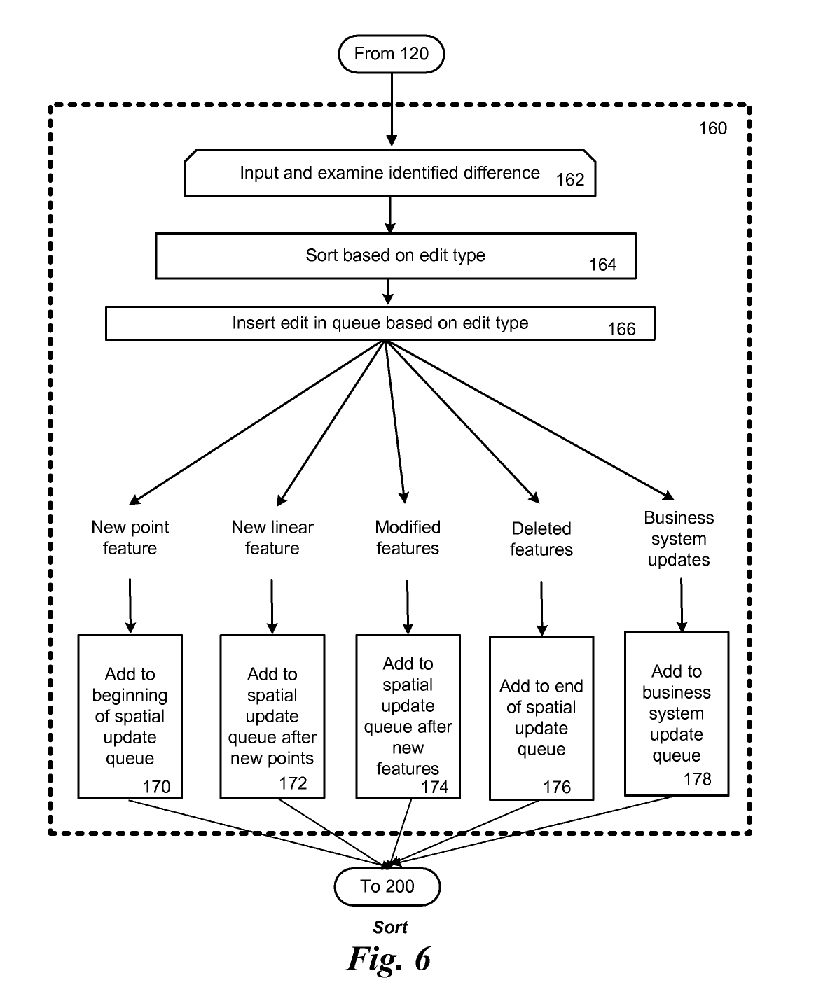

FIG. 6 depicts flowchart illustration of sub-algorithm 160 of FIG. 2. In general terms, FIG. 6 depicts a method to sort version differences. The categories are processed in a pre-defined order. Additions are processed first, then modifications, then deletions, and finally attribute only. This order is imposed to eliminate synchronization issues with the external Business System 400. For example, if a record is deleted in the external system prior to processing a modification that would have had a related effect on that record, then an exception could be produced that would disrupt the flow of the algorithm. The order of processing may change to accommodate the requirements of the external system. The identified feature is inserted in the queue and is subsequently classified according to new point feature, new linear feature, modified feature, or deleted feature. Each feature class is then placed in its queue location.

More particularly sub-algorithm 160 follows sub-algorithm 120 and begins with parallel processing 162 where identified differences from the GIS 20 submitted differences and/or the Business System 400 are inputted and examined. At processing block 164, the identified differences are sorted, followed by insertion and editing in queue based on the edit type at processing block 166. The queued and edited changes are than readied for the ordered sequential and preparation processing by new point features, new linear feature, modified feature, feature deletion, and Business System 400 updating sequential procedures, respectively denoted by processing blocks 170, 172, 174, 176, and 178. In processing block 170, a new point feature is added to the beginning of a spatial update queue. In processing block 172, a new linear feature is added to the spatial update queue after the new point feature. In processing block 174, modification of the features is added to the spatial update queue after the new features are added. In processing block 176, those features being deleted are added to the end of the spatial update queue. In processing block 178, business system updates are added to the business system 400 update queue. Thereafter, sub-algorithm 160 is completed by exiting processing blocks 170, 172, 174, 176, and 178 and proceeds to sub-algorithm 200.

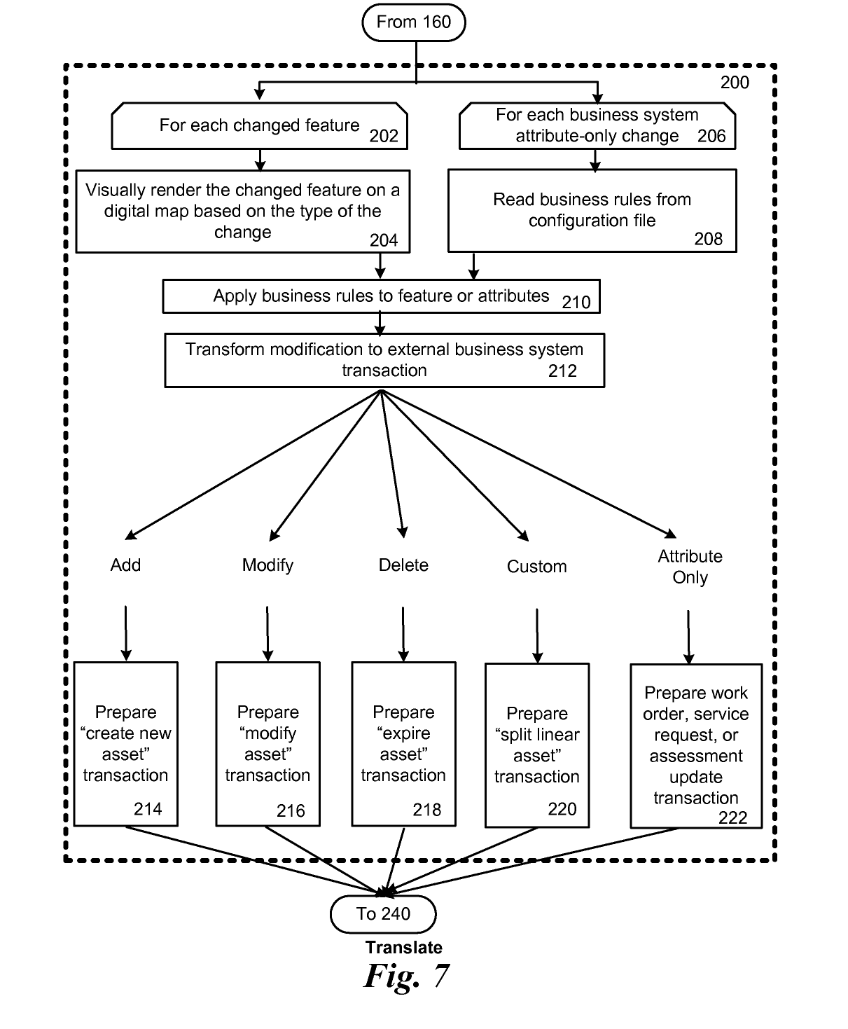

FIG. 7 depicts a flow chart illustration of sub-algorithm 200 of FIG. 2. Sub-algorithm 200 concerns how to translate version differences by identifying at least one difference between dataset versions and then places the pending GIS transaction in a queue. The differences are visually rendered, and custom business rules are applied if applicable. Business system attribute only changes are selected and business rules are read from a configuration file. The differences are translated to business system transactions. These transactions either create a new asset, modify asset, expire asset, customize, such as split linear feature, or modify attributes only. All transactions are submitted via business system API, or directly, to the business system, and a report log is generated.

More particularly sub-algorithm 200 follows from sub-algorithm 160 and begins with parallel processing blocks 202 and 206. At processing block, 202 inputting of changed features is readied for examination features, and at processing block, 206 attribute-only changes are inputted from the Business System 400 and readied for application of business rules. From processing block 202, the changed feature is visually rendered on a digital map based on the type of change at processing block 204, and thereafter, at processing block 210 business rules are applied to the changed features. From processing block 206, the business rules are read from a configuration file at processing block 208, and thereafter business rules are applied to the attributes only change features are applied at processing blocks 210.

Referring still to FIG. 7, from processing block 210, a transform modification to the transaction from the Business System 400 is applied at block 212. The transformed transaction is then prepared for parallel preparation processing by addition, modification, deletion, customization, and attribute only procedures, respectively denoted by processing blocks 214, 216, 218, 220, and 222. In processing blocks 214, a new asset transaction is created. In processing blocks 216, an asset transaction is modified. In processing block 218, an asset transaction is expired. In processing blocks 220, a transaction is linearly split. In processing blocks 222, a work order, service request, or assessment update is applied to the attribute-only transaction. Thereafter, sub-algorithm 200 is completed by exiting processing blocks 214, 216, 218, 220, and 222 and proceeds to sub-algorithm 240.

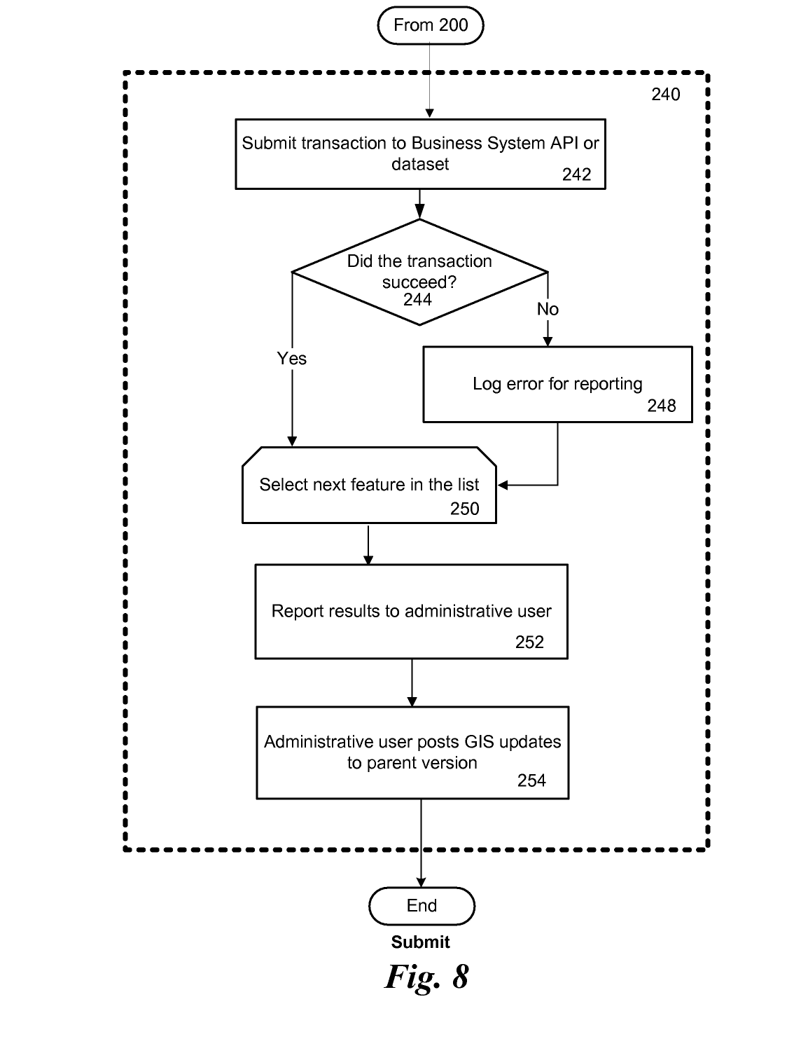

FIG. 8 depicts a flow chart illustration of sub-algorithm 240 of FIG. 2. In general terms, FIG. 8 describes how the sub-algorithm 240 submits transactions to the external business system 400 and how to post spatial changes to the parent version in the geodatabase 22. Based on the type of edit being processed, as well as any specific business rules applied, a transaction is prepared to be submitted to the business system 400 via the system's API 410 or directly to the business database 420. For example, for a newly created feature, a data structure is created to contain the necessary properties and values to recreate the record in the external business system 400. The data structure is then serialized into a format that is accepted by the external API 410 or business dataset in the business database 420. If the API 410 is web service-based, the message is typically formatted as extensible markup language (XML) with a Simple Object Access Protocol (SOAP) header and transmitted via hypertext transfer protocol (HTTP). If the API is COM-based, the data might be passed in a proprietary binary format.

A typical business system action for an added GIS feature is to create a corresponding inventory record. A typical action for a modification to a GIS feature is to update an inventory items attributes, or in a more specific case, to change the behavior or connectivity of an inventory item in a utility network. A typical action for a deleted GIS feature is to remove or expire a corresponding inventory record. A typical action for changed business system attributes is to apply the changes to the corresponding work order, service request, or assessment in that external system.

Referring still to FIG. 8, more particularly sub-algorithm 240 follows sub-algorithm 200 and begins with processing block 242 wherein the transaction or dataset is submitted to the Business system API 410 or business system database 420. A query “Did the transaction succeed” is present in decision diamond 244. If negative, an error log for reporting is accomplished at processing block 248, and a next feature is selected from the list at block 250. If affirmative, a next feature is selected from the list at processing block 250, and thereafter, at process block 252, results are reported to the administrative user. Sub-algorithm 240 and GSA algorithm 100 is them completed by execution of process block 254 wherein the administrative user posts the GIS updates of the parent version 30 to the GIS 20 database 22.

FIG. 9 depicts a flowchart illustration of an example embodiment of the use of the GeoResults Sync algorithm 100 of FIG. 1. The application of the GSA 100 is presented along a reconciliation timeline on the right side of FIG. 9 in which the progression of version reconciliation occurs of the child versions 40 with parent version 30. The timeline is shown beginning within the variation of the Geographical Information System 20, 20A, and spanning across and through the two variations the Business System 400, 400A and 400B, similar to those illustrated in FIG. 1. The top “in the office” relates to GIS 20A, the middle “in the field” relates to Business System 400A, and the bottom “in the office” relates to Business System 400B.

The timeline is shown progressing from GIS 20A where initiation or initial prepping and assignment occurs, then to and through Business System 400A, in which child versions 40 are processed using GeoResults, GeoResults Data Loader, GeoResults Mobile GoCollect, GeoResults Mobile Compact, GeoResults Mobile GoWork, GeResults Mobile GoRespond, and GeoResults Mobile GoAssess described in FIGS. 3A-4C. The “In the field” 400A includes an option wherein the changes to both system data could also be done in an office by an editor. Thereafter, the reconciliation timeline continues to and within the Business System 400B that undertakes the identify, sort, translate, and submit sub-algorithms described in FIGS. 5-8.

In other general terms, FIG. 9 presents an example of using the computer executable synchronization algorithm in the form of the GeoResults Sync algorithm 100 with a timeline going down the page, starting in an office 20A associated with the GIS 20, doing some “in the field” 400A work and checking changes back in the enterprise “in the office” Business System 400B, again both being 400A and 400B being versions of the Business System 400 of FIG. 1. Both GIS 20A and enterprise Business System 400A and 400B are kept in synchronization throughout by application of the GSA 100.

In the following is an example of work flow steps using an exemplary business system 400 vendor, referred to as “Hansen”, another exemplary business system version 400B. The Hansen business system 400B includes a GIS 20A parent version 30 file that is reconcilable with the child version 40. A temporary business data cache is utilized to identify differences, sort changes, translate transaction, and submit transactions per FIGS. 5-8 described above. The transactions are received into the Hansen Database and child versions are posted to the GIS Database of GIS system 20A.

1. Administrative User prepares GIS dataset by checking out a child version; and assigns work orders, service requests or assessments to a field user.

2. Staff make edits using GeoResults Mobile modules in the field or GeoResults Toolbox or Data Loader in the office, or with other ESRI-based editing tool

3. Administrative User reconciles changes posted by field or office staff.

4. Administrative User examines Editors version and accepts all changes

5. Administrative User reconciles the Editor's version to the parent version of the geodatabase.

6. Administrative User Identifies, Sorts, Translates and Submits changes using the GeoResults Sync algorithms

7. A form pops up which allows the Administrative User to select which feature dataset (Water, Sewer, or Reclaim) to synchronize with Hansen.

8. After the Administrative User clicks OK, the tool performs the following functions:
a. Examines the Editor's version for Sewer, Water, and Reclaim, compares the Editor's version to the protected/QA version to find changes and updates to the geodatabase including features that have been added, modified, deleted, split, merged, or flipped.
b. If required, GeoResults Sync has the ability to generate and/or modify unit identification values or UNITID values, a key component of the link between GIS 20 and Hansen 400B during this pre-processing step.
c. Based on the previous step, a pre-report outlining all differences between the editor's child version and parent or QA version of the geodatabase, and corresponding actions that will be taken in the external enterprise business system, will be produced. The Senior Analyst reviews this report for accuracy and completeness. This report also includes details of changes that cannot be synchronized with Hansen, usually due to missing or corrupt data. The Administrative User must decide whether to stop the process and attempt to fix data problems or to click OK to continue and synchronize the correct features.
d. These newly created or modified features or assets will be created in Hansen and the corresponding identifier “COMPKEY” will be populated in the GIS 20.
e. For all newly created and updated GIS features, the tool may utilize user provided field mappings to synchronize attribute values from GIS 20 to Hansen 400B. The synchronize process will overwrite modified asset attributes, depending on how the corresponding fields are mapped. The synchronize process will also work with custom fields defined by the City.
f. Finally, a report is created that outlines all of the changes made by GeoResults Sync and details whether the change to Hansen succeeded or failed. This report may be saved by the Administrative User for future reference.
g. As long as the Administrative User does not post the changes from the Editor's version to the protected quality assurance version, the GeoResults Sync 100 process can be run multiple times on the same set of changes. This allows an Editor to fix any problems that prevented successful reconciliation and redo the process.

FIG. 9 depicts a schematic of a particular embodiment of the GeoResults Sync algorithm 100 employing an editor that creates a version of the geodatabase 22 and makes changes over the course of a project or task, using the GeoResults Mobile modules in the field. Thereafter the GSA 100 reconciles the default parent 30 or historical version with the changes the GIS editor made in the child GIS dataset. An Administrator performs a GeoResults Sync process that identifies the differences of the undertaken project, in this case, a Hansen project with access provided via Hansen's GeoAdministrator. The Hansen Database, similar to the Business System 400 database 420, is accordingly synchronized and updated with the new attribute information from the GIS dataset or child version 40. Thereafter the user version is posted to the default or parent version.

More particularly for FIG. 9, the administrative user checks out the GIS child version 40 and assigns work orders, service requests, and/or assessments from the Business System 400. The editing user, then edits the GIS child version 40 and/or Business system data and submits the work to the Administrative user. The administrative user then reconciles the GIS 20 Database 22 child version 40 with the parent version 30. Then the administrative user runs the identify sub-algorithm 120 described in FIG. 5. Optionally, the administrative user may review and do a quality control test. Then the administrative user runs the Sort sub-algorithm 160 of FIG. 6, the translate sub-algorithm 200 of FIG. 7, and the submit routines described for sub-algorithm 240 of FIG. 8 to update the business system's 400 database 420.

While the particular embodiments have been illustrated and described for systems and method for creating and synchronizing datasets, many changes can be made without departing from the spirit and scope of the invention. For example, applications of the disclosed embodiments may be used for more than two data sets requiring synchronization. Accordingly, the scope of the invention is not limited by the disclosure of the preferred embodiment. Instead, the invention should be determined entirely by reference to the claims that follow.

The embodiments of the invention in which an exclusive property or privilege is: claimed are defined as follows:

1. A method for monitoring a changing geographical information system dataset version comprising:
obtaining an original dataset having an original attribute from a first database;
creating a duplicate dataset from the original dataset and storing on a second database;
modifying at least one attribute of the duplicate dataset to form a modified duplicate dataset;
detecting the difference between the modified at least one attribute with the original attribute; and
synchronizing and posting the modified dataset with the original dataset on the first and second databases.

2. The method of claim 1 wherein the original attribute includes at least one of spatial and alphanumeric data.

3. The method of claim 1 wherein the modified at least one attribute includes spatial and alphanumeric data.

4. A computer readable medium having computer-executable instructions to perform a method for monitoring a changing geographical information system dataset version comprising:
obtaining an original dataset having an original attribute from a first database;
creating a duplicate dataset from the original dataset and storing on a second database;
modifying at least one attribute of the duplicate dataset to form a modified duplicate dataset;
detecting the difference between the modified at least one attribute with the original attribute; and
synchronizing and posting the modified dataset with the original dataset on the first and second databases.

5. The computer readable medium of claim 4, wherein the original attribute includes at least one of spatial and alphanumeric data.

6. The computer readable medium of claim 4, wherein the modified at least one attribute includes spatial and alphanumeric data.

7. A computer-executable method for monitoring a changing geographical information system dataset version comprising:
obtaining an original dataset having an original attribute from a first database;
creating a duplicate dataset from the original dataset and storing on a second database;
modifying at least one attribute of the duplicate dataset to form a modified duplicate dataset;
detecting the difference between the modified at least one attribute with the original attribute; and
synchronizing and posting the modified dataset with the original dataset on the first and second databases.

8. The method of claim 7 wherein the original attribute includes at least one of spatial and alphanumeric data.

9. The method of claim 7 wherein the modified at least one attribute includes spatial and alphanumeric data.
